(19) United States
(12) Patent Application Publication
(10) Pub. No.: US 2007/0056916 A1
(43) Pub. Date: Mar. 15, 2007

(54) Rotatable desk organizer with lid

(76) Inventor: Rosario Marano, Cedar Grove, NJ (US)

Correspondence Address: Patrick P. Zaretski, Esq.;Law Offices, 51 Young Avenue, Totowa, NJ, 07512-2044, US

(21) Appl. No.: 11/226,874

(22) Filed: Sep. 14, 2005

(51) Int. Cl. B42F 17/00

(52) U.S. Cl. 211/10

(57) ABSTRACT

A rotatable desk organizer which features a plurality of horizontally-oriented slidable and removable shelves; specifically-shaped holders for particular individual office supplies or articles; a plurality of various-sized, removable cup-shaped holders; and a hinged or otherwise retractable or removable, lockable lid.

### TECHNICAL FIELD OF THE INVENTION

This invention relates to office equipment, and more particularly to a rotatable desk organizer.

### BACKGROUND ART

The use of modular desk organizers is well-known in the prior art. Such organizers permit the occupant of a desk to free up valuable desk room for writing or performing other space-taking tasks, to organize often-used supplies in an easily-accessible manner, and so on. Indeed, there have been a number of patents awarded to various embodiments of such organizers. For instance, in U.S. Pat. No. 5,377,850 to Liaw, there is disclosed a modular stationery stand which includes a rotary base having a large cylinder in the center and smaller cylinders mounted in the four corners; lower and upper cases bearing corresponding hollow cylinders, with many shell-shaped spaces; and a lattice cover which covers a pen case and has a hole to receive the hollow cylinders so as to form a rotating stationery stand with upper and lower layers.

However, each of these embodiments present their own problems to the user. For example, the prior art fails to reveal a desk organizer bearing shelves which are slidable to permit the user to access objects which are placed farther back upon those shelves and which are removable to permit the user to place larger-sized objects than those with all shelves in place within an allotted storage space. Additionally, the prior art fails to reveal a hinged and retractable or removable, lockable lid placed on top of the desk organizer which not only would securely cover any objects stored underneath but which would also provide for an additional writing surface on a crowded desk which the desk organizer would be placed upon. Next, while of course the prior art reveals desk organizers which may hold or contain office supplies, the prior art fails to reveal a desk organizer with storage spaces specifically shaped for an individual object, such as a calculator, personal display apparatus, or eyeglasses. Finally, for such standard office supplies as paper clips, mechanical pencil leads, staples, and so on, the prior art fails to reveal a plurality of various-sized, removable cup-shaped holders which will can contain each one of these supplies discretely from the others.

It would therefore be desirable to provide for a rotatable desk organizer which features a plurality of horizontally-oriented slidable and removable shelves; specifically-shaped holders for particular individual office supplies or articles; a plurality of various-sized, removable cup-shaped holders; and a hinged or otherwise retractable or removable, lockable lid.

### OBJECTS OF THE INVENTION AND INDUSTRIAL APPLICABILITY

Accordingly, it is a general object of the present invention to provide for a rotatable desk organizer which is lightweight, easy to manufacture and use, and which provides for increased capacity and ease to store or contain office supplies of various shapes and sizes.

It is an object of the present invention to provide for a rotatable desk organizer which features a plurality of horizontally-oriented slidable and removable shelves to allow for easier access to objects and increased storage capacity for larger objects.

It is a further object of the present invention to provide for a rotatable desk organizer which bears specifically-shaped holders for particular individual office supplies or articles such as a calculator, personal data assistant, or eyeglasses.

It is a still further object of the present invention to provide for a rotatable desk organizer which features a plurality of various-sized, removable cup-shaped holders to store office supplies of various shapes and sizes.

It is a still further object of the present invention to provide for a rotatable desk organizer which features a hinged and retractable or removable, lockable lid to securely cover any objects stored underneath and also provide for an additional writing surface.

### SUMMARY OF THE INVENTION

Consequently, to achieve these and other aims and objectives, the present invention provides for a cube-shaped desk organizer placed upon a circular rotary base with attaching spindle to permit the main organizer body to be rotated while staying in the same footprint on the desk surface. Each of the five remaining sides of the cube-shaped main organizer body bears a modality for storing or containing office supplies of various shapes and sizes. One side of the main organizer body manifests a plurality of horizontally-oriented shelves placed within a hollow containing space formed inside the interior of the main organizer body. These shelves are slidable outwardly from the hollow space to permit the user to access objects held within the containing space on the shelves more easily. In an alternative embodiment of the present invention, these shelves are removable to permit the user to place objects on the remaining shelving within the containing space whose dimensions would otherwise be too large to fit in the space with all the shelving in place. A second side of the main organizer body has specifically-shaped holders for particular office supplies or articles of personal effects; such office supplies may include, but not be limited to, eyeglasses, a writing implement, a calculator, or a personal data assistant. The third and fourth sides of the main organizer body each bear a plurality of cup-shaped holders to hold such small-sized, multitudinous office supplies as paper clips, rubber bands, staples, and so on. One of these sides may bear larger holders than the other to appropriately accommodate larger sized objects such as pens, smaller-sized rulers, and so on. In an alternative embodiment, one or more of these cup-shaped holders are removable to permit the user to move the entire amount of stored office supplies freely. Finally, on the fifth side, opposite the rotary base, there is placed a hinged or otherwise retractable or removable lid to cover or otherwise secure the contents placed underneath. While this lid may assume any shape or configuration, it is contemplated that there should be sufficient flat surface enough to permit the user to use the lid as an additional writing surface should one be needed. In an alternative embodiment of the present invention, this lid is able to be locked onto the surface of the main organizer body to prevent accidental losses of the contents underneath or to only permit the organizer's owner access to those contents.

### BRIEF DESCRIPTION OF THE DRAWINGS

For a fuller understanding of the nature and objects of the present invention, reference is made to the following specification, which is to be taken in connection with the accompanying drawings wherein:

FIG. 1 shows a top view of the desk organizer exemplifying the present invention, particularly illustrating the hinged lid;

FIG. 2 shows a bottom view of the desk organizer exemplifying the present invention, particularly illustrating the rotary base;

FIG. 3 shows a forward view of the desk organizer exemplifying the present invention, particularly illustrating the slidable horizontal shelves;

FIG. 4 shows a left view of the desk organizer exemplifying the present invention, particularly illustrating the writing instrument holder and object holder;

FIG. 5 shows a rear view of the desk organizer exemplifying the present invention, particularly illustrating the two large cup-shaped object holders; and

FIG. 6 shows a right view of the desk organizer exemplifying the present invention, particularly illustrating the four smaller cup-shaped object holders.

### DETAILED DESCRIPTION OF THE DRAWINGS

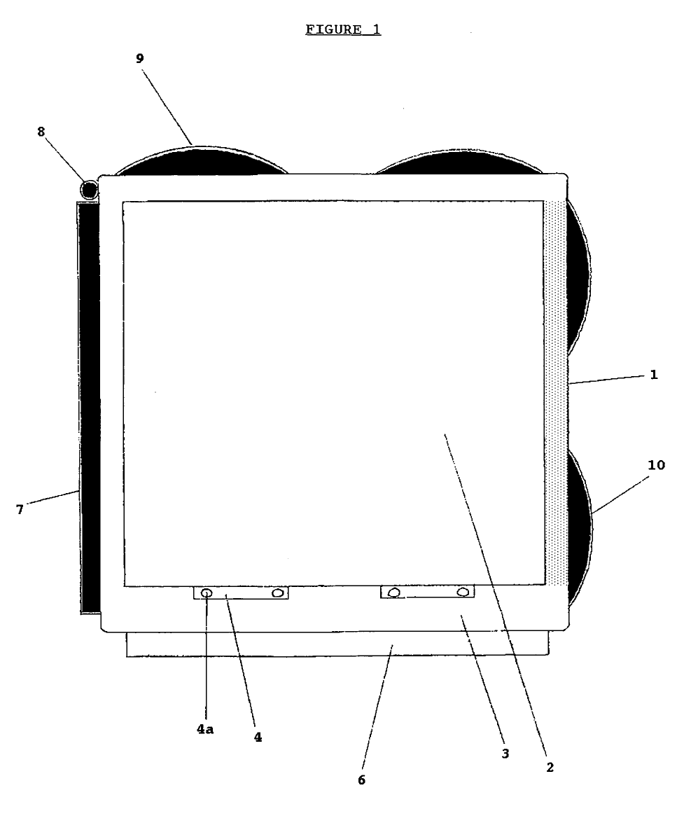

There is depicted in FIG. 1 a top view of cube-shaped desk organizer 1. The dimensions of the main organizer body 1 may be anywhere up to 18 inches (″) by 18″ by 18″ and may be constructed from any type of lightweight moldable material, such as plastic. Additionally, the main organizer body 1 may be any appropriate color to best blend in with contemporary office decor. As seen in this illustration, on one of the six sides of the main organizer body 1, there is disposed a lid 2, constructed from the same or similar material as the main organizer body 1, leaving an open surrounding surface 3 of the side of the main organizer body 1 uncovered by the lid 2. While the lid 2 is depicted here as a flat cube shape, the lid 2 may assume any shape or configuration, be that circular, triangular, pyramidal, etc. However, to ease the user's ability to write down information on a crowded desktop, some portion of the surface of the lid 2 should be flat enough to lay a piece of paper or sticky note level to the surface to facilitate writing. Also in this illustration, to prevent the lid 2 from slipping off the main organizer body 1, the lid 2 is affixed in place along one edge of its surface by a plurality of hinges 4 affixed to the main organizer body by bolts 4a or other appropriate means known in the art. The hinges 4 thus permit the lid 2 to describe a limited axis of rotation around the main organizer body 1, which thereby allows the user to raise or lower the lid 2 and have access to the storage space formed underneath. In an alternative unillustrated embodiment of the present invention, the lid 2 may be locked or secured onto the surrounding open surface 3 of the main organizer body 1 by a locking or securing means to prevent accidental losses of the contents underneath or to only permit the organizer's owner access to those contents. In a second unillustrated embodiment of the present invention, the lid 2 is not permanently affixed to the main organizer body 1 by hinges 4 or other securing means but is instead removable to allow the user access to the entire surface of this side of the main organizer body 1 at the user's election.

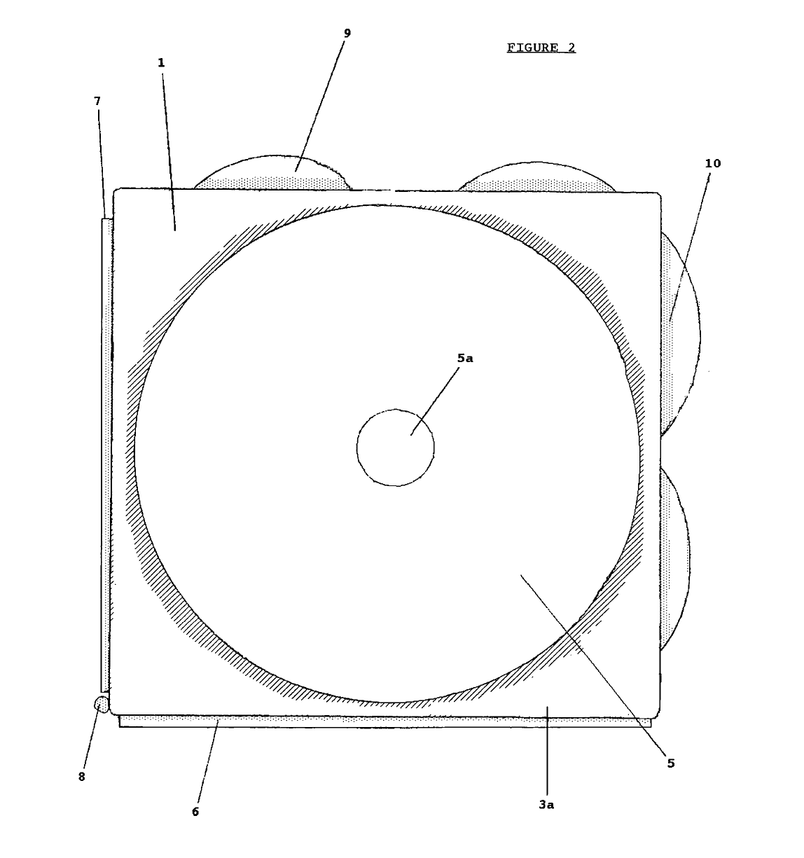

Turning to FIG. 2, the bottom side of the main organizer body 1 opposite to the side bearing the lid 2 has a rotary base 5, constructed of the same or similar material to that of the main organizer body 1, affixed to the surface of the main organizer body 1 by a spindle 5a. The rotary base 5 is depicted here as being circular in shape, but any geometric shape, such as a triangle or square, is herein contemplated. Furthermore, the dimensions of the rotary base 5 should be sufficient to cover at least one-half of the area of this side of the main organizer body 1, while still leaving some open surrounding surface 3a, to provide for a large enough footprint on a desk surface to prevent the main organizer body 1 from being unstable while rotating but small enough not to interfere with the placement or function of the various other features of the present invention.

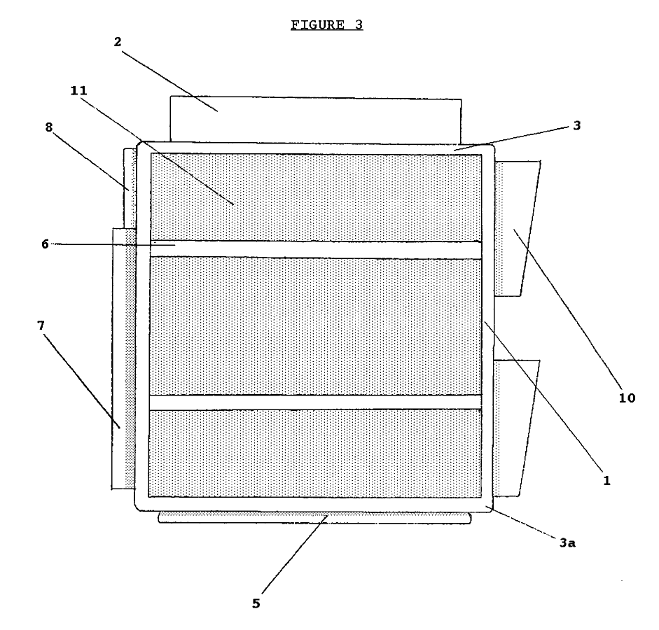

As illustrated in FIG. 3, one of the lateral sides of the main organizer body 1 is open into a hollow chamber 11 which extends nearly the entire length, depth, and width of the main organizer body 1. Within this chamber 11, a plurality of shelves 6 is inserted to place office supplies upon. In FIG. 3, two shelves 6 are illustrated, but any practicable number of shelves 6 may be inserted into the chamber 11. The shelves 6 are to be horizontally slidable may be affixed into the chamber 11 via a tongue-and-groove or wheeled-rail means, or any other means known to the art (unillustrated). By having the shelves 6 horizontally slidable, the user has access to the entire length of the shelves 6 and shall be able to reach articles located at the very end of the shelves 6 without having to reach back inside the chamber 11. Additionally, in an unillustrated embodiment of the present invention, the shelves 6 are freely removable either individually or jointly, thereby letting the user insert objects of a greater height than that of an individual storage space formed by the height between two shelves 6, or between a shelf and the ceiling or floor formed by the open surrounding surfaces 3 and 3a of the main organizer body 1.

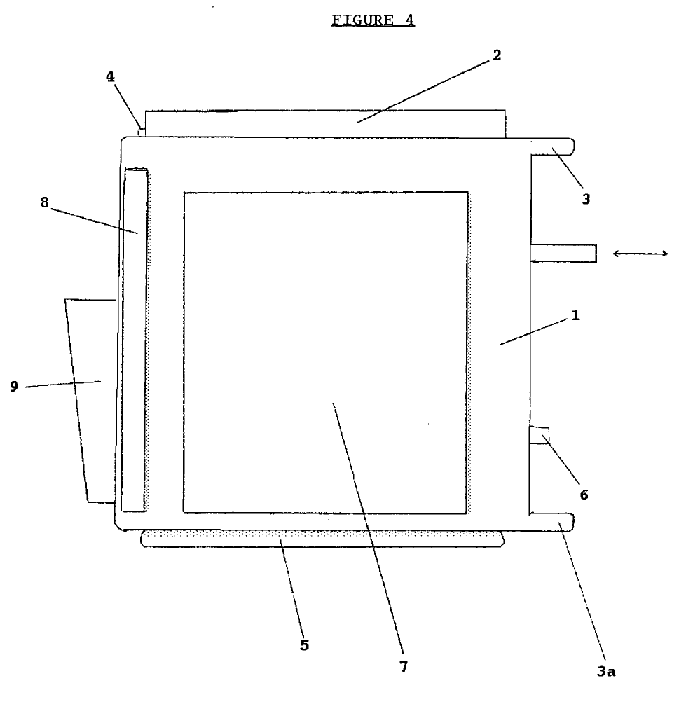

Next, as seen in FIG. 4, one lateral side of the main organizer body 1 bears on its surface a number of differently-sized holders 7 and 8 shaped to contain particular individual office supplies articles which the user may have recourse to use more frequently than others and which may be too bulky or inappropriate to place on one of the shelves 6. While these holders may be constructed of the same material as that of the main organizer body 1 (i.e., of any type of lightweight moldable material), for esthetic and practical reasons, such as repeated insertion and removal of the articles, it is contemplated that the material should be of a different composition, such as leather or nylon, to prevent damage to the holders 7 and 8 from repeated use and to prevent wear to the articles being inserted therein. The large holder 7 in FIG. 4 is designed to hold larger individual office supplies articles, such as a calculator, a personal data assistant, a pair of eyeglasses, folded-up notes, etc. The smaller holder 8 is designed to hold smaller such articles, such as a pen, a laser pointer, etc. While FIG. 4 illustrates only two of such holders, the larger holder 7 and the smaller holder 8, it is contemplated that any practicable number of combinations of such holders may be placed upon the main organizer body 1.

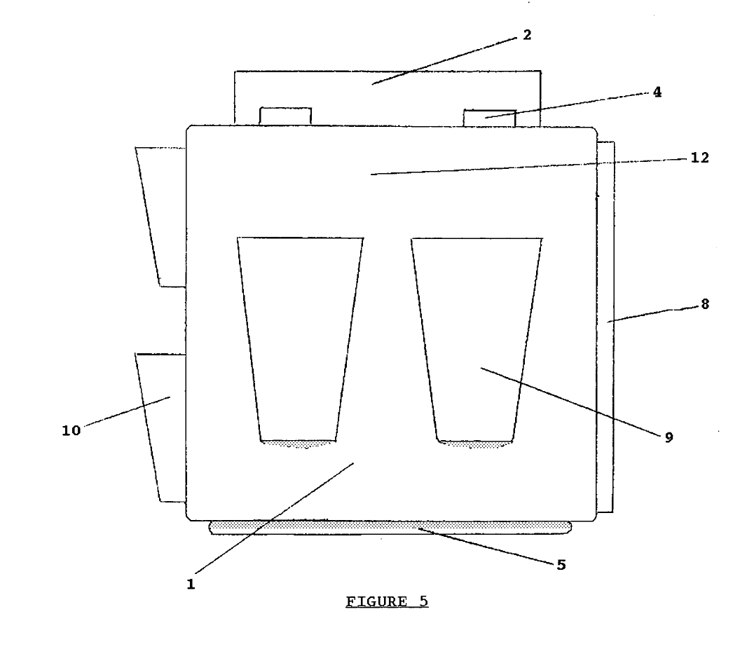

As illustrated in FIG. 5, one of the lateral sides of the main organizer body 1 bears a plurality of large cup-shaped holders 9. These holders 9 may be fabricated from the same material as that of the main organizer body 1, or from a similar material. It is contemplated that the height of each holder 9 should be at least one-half the height of this side of the main organizer body 1. Despite the large size of the holders 9, there is sufficient unused area 12 left on the side of the main organizer body 1 for the placement of alphanumeric or graphical information, such as the owner's name, company logo, decorations or blandishment, etc. The holders 9 may be molded directly from the material forming the side of the main organizer body 1; permanently affixed to the main organizer body 1 such as through glue, soldering, heat-sealing, or other appropriate means known through the art; or, in an alternative unillustrated embodiment, detachable from the main organizer body 1, and able to be carried about by the user, and reattached to the main organizer body 1 through the use of velcro strips or other appropriate means known to the art. The large size of the holders 9 permits the user to place such larger-sized office supplies articles in the holders 9 as markers, small-sized rulers, scissors, and so on.

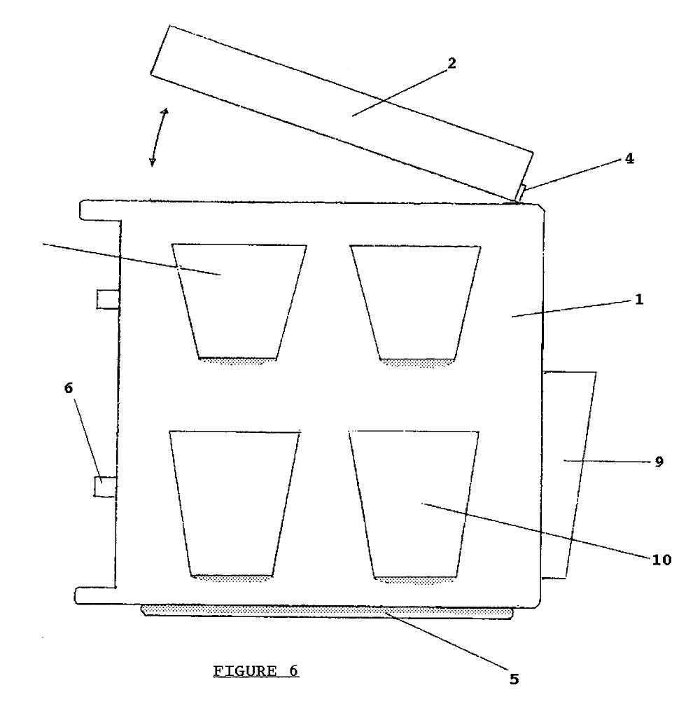

Alternatively, on the final remaining lateral side of the main organizer body 1 as depicted in FIG. 6, there are placed a plurality of small cup-shaped holders 10. The size of these holders 10 permits their placement one on top of the other, so as to maximize the storage capacity of this side of the main organizer body 1. As with the large-sized holders 9, the small holders 10 may be molded directly from the material forming the side of the main organizer body 1; permanently affixed to the main organizer body 1 such as through glue, soldering, heat-sealing, or other appropriate means known through the art; or, in an alternative unillustrated embodiment, detachable from the main organizer body 1, able to be carried about by the user, and reattached to the main organizer body 1 through the use of velcro strips or other appropriate means known to the art. However, given the smaller size of these holders 10, appropriate office supplies articles which may be placed therein include rubber bands, pushpins, paper clips, business cards, and so on.

The rotatable desk organizer described herein was described according to a particular embodiment and alternatives thereof. However, it is contemplated that the inventive aspects of this rotatable desk organizer may be used with different numbers of objects, measurements of objects, or design specifications of those inventive aspects. For example, the lid 2 may be affixed to the top side of the main organizer body 1 with velcro strips rather than a plurality of hinges 4. Thus, while the present invention has been described in connection with exemplary embodiments thereof, it will be understood that many modifications in both design and use will be apparent to those of ordinary skill in the art, and this application is intended to cover any adaptations or variations thereof. It is therefore manifestly intended that this invention be limited only by the claims and the equivalents thereof.

The invention to be claimed is:

1. A rotatable desk organizer, comprising:
a cube-shaped main body,
said main body being hollowed out along substantially along its height, width and depth to form an interior chamber,
said interior chamber opening out to one side of the main body;
a rotary base upon which said main body is placed,
said rotary base affixed to said main body by a spindle,
said spindle permitting said main body to rotate freely upon said rotary base;
a lid placed upon the side of said main body opposite that side which is placed upon said rotary base;
a plurality of shelves,
said shelves being movably placed within said interior chamber;
a large individual object holder and a small individual object holder,
said individual object holders both placed upon the same surface of one of the remaining sides of said main body;
a plurality of large cup-shaped holders placed on the surface of one of the remaining sides of said main body; and
a plurality of cup-shaped holders placed on the surface of the last remaining side of said main body,
wherein said cup-shaped holders are relatively smaller than those of said large cup-shaped holders.

2. The desk organizer of claim 1, wherein the dimensions of said main body are 18″ by 18″ by 18″.

3. The desk organizer of claim 1, wherein said main body is constructed from plastic.

4. The desk organizer of claim 1, wherein said lid is affixed to said main body by a securing means.

5. The desk organizer of claim 4, wherein said securing means is a plurality of hinges affixed to one side of said lid.

6. The desk organizer of claim 1, further comprising a locking means to lock said lid into onto said main body.

7. The desk organizer of claim 1, wherein said shelves are movable along a tongue-and-groove means formed with said interior chamber.

8. The desk organizer of claim 1, wherein said shelves are movable along a track formed by placing wheels upon two sides of said shelves and a complementary track within said interior chamber.

9. The desk organizer of claim 1, wherein said shelves are freely removable from and replaceable in said interior chamber.

10. The desk organizer of claim 1, wherein said individual object holders are formed from a different material than that of said main body and affixed to said main body.

11. The desk organizer of claim 10, wherein the material forming the individual object holders is to be selected from a group consisting of leather, fake leather, or nylon.

12. The desk organizer of claim 1, wherein said cup-shaped holders are approximately one-half the height of said large cup-shaped holders.

13. The desk organizer of claim 1, wherein said cup-shaped holders and said large cup-shaped holders are removable from said main body.

14. The desk organizer of claim 1, further comprising alphanumeric or graphical information to be affixed to said main body above said large cup-shaped holders.
